(19) United States
(12) Patent Application Publication
(10) Pub. No.: US 2022/0266661 A1
(43) Pub. Date: Aug. 25, 2022

(54) SCENT OUTPUT CONTROL DEVICE, SCENT OUTPUT CONTROL SYSTEM AND METHOD, AND PROGRAM

(71) Applicant: SONY GROUP CORPORATION, TOKYO (JP)

(72) Inventors: CEDRIC DUVERT, TOKYO (JP); SATOSHI KONYA, TOKYO (JP); SHUJI FUJITA, TOKYO (JP); YUKITO INOUE, TOKYO (JP)

(21) Appl. No.: 17/628,461

(22) PCT Filed: Jul. 7, 2020
(86) PCT No.: PCT/JP2020/026609

§ 371 Date: Jan. 19, 2022

(30) Foreign Application Priority Data
Aug. 5, 2019 (JP) 2019-143652

(51) Int. Cl. B60H 3/00; G06F 3/0482

(52) U.S. Cl. CPC B60H 3/0007; G06F 3/0482

(57) ABSTRACT

To realize a device and method for controlling a scent to be output on the basis of various types of information acquired by an information acquisition unit. The device includes a scent output control unit that executes a scent output control, and a scent output unit that executes a scent output under the control of the scent output control unit, in which the scent output control unit selects a scent to be output according to input information from the information acquisition unit, and outputs the selected scent via the scent output unit. The scent output control unit selects information to be used for scent selection from the input information according to a preset mode, and selects a scent to be output according to the selected input information. For example, the control of the scent to be output is executed on the basis of a user utterance or information of an area, a facility, or the like.

### TECHNICAL FIELD

The present disclosure relates to a scent output control device, a scent output control system and method, and a program. More specifically, the present disclosure relates to a scent output control device, a scent output control system and method, and a program for outputting various scents depending on situations in a vehicle such as an automobile.

### BACKGROUND ART

For example, there are users of automobiles such as passenger cars often install fragrances in their cars in order to give off a scent in vehicles of automobiles.

There are various types of fragrances, for example, lavender, lemon, jasmine, and the like, and users can install fragrances in their vehicles to give off favorite scents in their vehicles.

Furthermore, a configuration for notifying occupants such as a driver of guidance information using a scent has also been proposed.

For example, Patent Document 1 (Japanese Patent Application Laid-Open No. 2001-349739) discloses a scent releasing configuration for guiding a place, a facility, or the like to occupants such as a driver of an automobile.

In a case where an automobile approaches a specific place, a facility, or the like, a specific scent is automatically released and guided to a driver or the like.

Furthermore, Patent Document 2 (Japanese Patent Application Laid-Open No. 2010-111315) discloses a configuration in which a scent is released according to a transition of a display of a traffic light to provide notification, by the scent, that the display of the traffic light has been changed.

### CITATION LIST

### Patent Document

Patent Document 1: Japanese Patent Application Laid-Open No. 2001-349739
Patent Document 2: Japanese Patent Application Laid-Open No. 2010-111315

### SUMMARY OF THE INVENTION

### Problems to be Solved by the Invention

As described above, there is a plurality of conventional techniques that discloses notification processing by a scent. However, the configuration described in Patent Document 1 merely discloses a scent release configuration depending only on map information.

In addition, Patent Document 2 merely discloses a scent releasing configuration in conjunction with display of a traffic light.

An object of the present disclosure is to provide a scent output control device, a scent output control system and a method, and a program that enable control of an output timing and an output interval of a scent, and further analyze various input information such as utterance contents of a user such as a driver or an occupant of an automobile or a word that is a topic acquired from a network to control a scent to be released.

### Solutions to Problems

A first aspect of the present disclosure provides

a scent output control device, including:

a scent output control unit configured to execute scent output control; and

a scent output unit configured to execute a scent output under control of the scent output control unit, and

in which the scent output control unit

is configured to select a scent to be output according to input information from an information acquisition unit, and output the selected scent via the scent output unit, and

select information to be used for scent selection from the input information according to a preset mode, and select a scent to be output according to the selected input information.

Furthermore, a second aspect of the present disclosure provides

a scent output control system including: a scent output control device configured to execute a scent output process; and a scent output mode determination server configured to determine a scent to be output in the scent output control device,

in which the scent output control device transmits information acquired by an information acquisition unit to the scent output mode determination server,

the scent output mode determination server determines a scent to be output according to information received from the scent output control device, and transmits information on the determined scent to the scent output control device,

the scent output control device is configured to output the scent determined by the scent output mode determination server via a scent output unit, and

the scent output control device selects information to be used for scent selection from the information acquired by the information acquisition unit according to a preset mode, and transmits the selected information to the scent output mode determination server.

Furthermore, a third aspect of the present disclosure provides

a scent output control method executed in a scent output control device,

in which the scent output control device includes:

a scent output control unit configured to execute scent output control; and

a scent output unit configured to execute a scent output under control of the scent output control unit, and

the scent output control unit

executes a process of selecting a scent to be output according to input information from an information acquisition unit, and outputting the selected scent via the scent output unit, and

selects information to be used for scent selection from the input information according to a preset mode, and selects a scent to be output according to the selected input information.

Furthermore, a fourth aspect of the present disclosure provides

a scent output control method executed in a scent output control system including a scent output control device configured to execute a scent output process, and a scent output mode determination server configured to determine a scent to be output in the scent output control device,

in which the scent output control device selects information to be used for scent selection from information acquired by an information acquisition unit according to a preset mode, and transmits the selected information to the scent output mode determination server,

the scent output mode determination server determines a scent to be output according to information received from the scent output control device, and transmits information on the determined scent to the scent output control device, and

the scent output control device outputs the scent determined by the scent output mode determination server via a scent output unit.

Furthermore, a fifth aspect of the present disclosure provides

a program for causing a scent output control device to execute scent output control,

in which the scent output control device includes:

a scent output control unit configured to execute scent output control; and

a scent output unit configured to execute a scent output under control of the scent output control unit, and

the program causes the scent output control unit to:

execute a process of selecting a scent to be output according to input information from an information acquisition unit, and outputting the selected scent via the scent output unit; and

select information to be used for scent selection from the input information according to a preset mode, and select a scent to be output according to the selected input information.

Note that the program of the present disclosure is, for example, a program that can be provided, by a storage medium or a communication medium provided in a computer readable format, to an information processing apparatus, an image processing apparatus, or a computer system capable of executing various program codes. By providing such a program in a computer-readable format, processing according to the program is realized on the information processing apparatus or the computer system.

Still other objects, features, and advantages of the present disclosure will become apparent from more detailed description based on embodiments of the present disclosure described later and the accompanying drawings. Note that, in the present specification, a system is a logical set configuration of a plurality of devices, and is not limited to a system in which devices of respective configurations are in the same housing.

According to a configuration of an embodiment of the present disclosure, the device and method for controlling a scent to be output on the basis of various types of information acquired by an information acquisition unit are realized.

Specifically, for example, a scent output control unit that executes scent output control and a scent output unit that executes a scent output under the control of the scent output control unit are included, and the scent output control unit selects a scent to be output according to the input information from the information acquisition unit and outputs the selected scent via the scent output unit. The scent output control unit selects information to be used for scent selection from the input information according to a preset mode, and selects a scent to be output according to the selected input information. For example, the control of the scent to be output is executed on the basis of a user utterance or information of an area, a facility, or the like.

With this configuration, the device and method for controlling a scent to be output on the basis of various types of information acquired by the information acquisition unit are realized.

Note that the effects described in the present specification are merely examples and are not limited, and other effects may be obtained.

### BRIEF DESCRIPTION OF DRAWINGS

FIG. 1 is a diagram for describing a usage example of a scent output control device of the present disclosure.

FIG. 2 is a diagram for describing a usage example of the scent output control device of the present disclosure.

FIG. 3 is a diagram for describing a configuration example of the scent output control device of the present disclosure.

FIG. 4 is a diagram illustrating an example of information acquired by an information acquisition unit.

FIG. 5 is a diagram for describing a detailed configuration example of a scent output control unit of a scent output control device.

FIG. 6 is a diagram illustrating an example of data displayed on an input/output unit (UI).

FIG. 7 is a diagram for describing a setting mode of the scent output control device of the present disclosure.

FIG. 8 is a diagram for describing a scent output control process in a current location correspondence mode.

FIG. 9 is a diagram for describing a position used in the current location correspondence mode and a data configuration example of a facility correspondence scent database.

FIG. 10 is a diagram for describing configuration data of a scent output mode recorded in a mode correspondence scent database such as a position and a facility correspondence scent database.

FIG. 11 is a diagram for describing a scent output control process in a current location correspondence mode.

FIG. 12 is a diagram for describing a scent output control process in a word correspondence mode.

FIG. 13 is a diagram for describing a data configuration example of a word correspondence scent database used in the word correspondence mode.

FIG. 14 is a diagram for describing a configuration example of a scent output control device having a system configuration in which processing is performed on a server side.

FIG. 15 is a diagram for describing a configuration example of the scent output control device of the present disclosure having a system configuration in which processing is performed on the server side.

FIG. 16 is a flowchart for describing a sequence of processes executed by the scent output control device of the present disclosure.

FIG. 17 is a flowchart for describing a sequence of processes executed by the scent output control device of the present disclosure.

FIG. 18 is a diagram for describing a hardware configuration example of the scent output control device.

### MODE FOR CARRYING OUT THE INVENTION

Hereinafter, details of a scent output control device, a scent output control system and method, and a program of the present disclosure will be described with reference to the drawings. Note that the description will be made according to the following items.

1. For configuration and processing of scent output control device of the present disclosure

2. For configuration of scent output control unit and processing executed

3. For specific example of scent output control executed by scent output control device of the present disclosure

3-(1) For example of scent output control in current location correspondence mode

3-(2) For example of scent output control in word correspondence mode

4. For configuration example of executing scent output mode determination processing in external server

5. For sequence of processing executed by scent output control device of the present disclosure

6. For business deployment example using scent output control processing of the present disclosure

7. For hardware configuration example of scent output control device

8. Summary of configuration of the present disclosure

[1. For Configuration and Processing of Scent Output Control Device of the Present Disclosure]

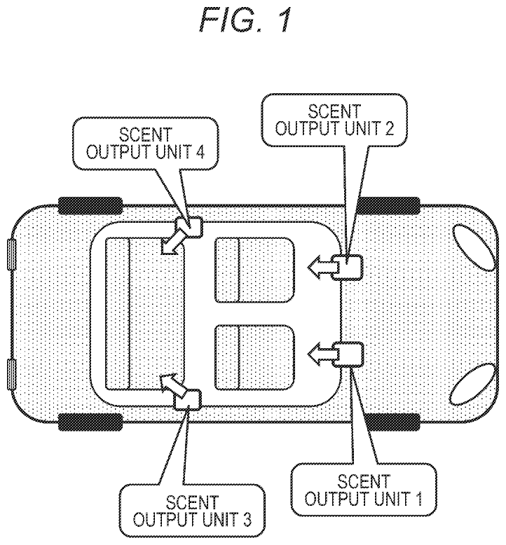

The configuration and processing of the scent output control device of the present disclosure will be described with reference to FIG. 1 and subsequent drawings.

FIG. 1 is a diagram illustrating a usage example of a scent output control device of the present disclosure. As illustrated in FIG. 1, the scent output control device of the present disclosure is mounted on a mobile device such as a passenger car. Note that the scent output control device of the present disclosure is not limited to vehicles such as passenger cars, but can be mounted on various moving devices such as trains, motorcycles, and bicycles.

Hereinafter, as a representative example, an embodiment in a case where the scent output control device of the present disclosure is mounted on a vehicle that is an automobile such as a passenger car will be described.

As illustrated in FIG. 1, a scent output unit that outputs (jets) a scent component is mounted on each seat of a vehicle.

A scent output unit 1 outputs a scent component to an occupant in a right front seat of the vehicle, for example, a driver.

A scent output unit 2 outputs a scent component to an occupant in a left front seat of the vehicle.

A scent output unit 3 outputs a scent component to an occupant in a right back seat of the vehicle.

A scent output unit 4 outputs a scent component toward an occupant in a left rear seat of the vehicle.

The scent output control device of the present disclosure controls the output of the scent from each of these scent output units 1 to 4.

Note that the number and arrangement of the scent output units can be set in various ways.

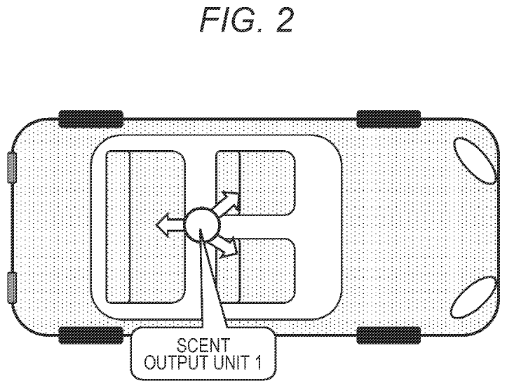

For example, as illustrated in FIG. 2, one scent detection unit 1 may be provided at a center of the vehicle ceiling to selectively output a scent toward each seat.

Note that, in the configuration of the present disclosure, the scent output unit has a configuration capable of selectively outputting various types of scents such as forest scents, ramen scents, hamburger scents, and cosmetics scents, in addition to scents such as lavender, lemon, and jasmine.

Although the details will be described later, the scent output control device of the present disclosure enables control of the output timing and output interval of the scent, and further has a configuration that analyzes various input information such as utterance contents of a user such as a driver or an occupant of an automobile, a word that is a topic acquired from a network, and the like to control the released scent.

The scent output unit stores various different scent components in individual cartridges, and the control unit of the scent output control device performs control to select one cartridge and output (jet) the scent component in the cartridge to the outside.

The scent output unit is controlled by a scent output control unit. The scent output control unit performs a process of selecting the type of the output scent, and further executes a start/stop process of the scent output. Furthermore, the remaining amount of the scent component in the cartridge can be detected, and in a case where the remaining amount becomes small, an alarm output or the like is executed.

Note that an example of a configuration of an existing scent output unit is AROMASTIC manufactured by Sony Corporation. AROMASTIC manufactured by Sony Corporation outputs a scent using Sony's unique Scentents (registered trademark) technology. Specifically, the method is a method of perfuming air itself by a gas diffusion method by blower processing of blowing dry air into a cartridge.

The scent output unit of the scent output control device of the present disclosure is, for example, a scent output unit using this scheme, and the control unit executes switching of the scent type of each unit, control of scent output intensity, and the like.

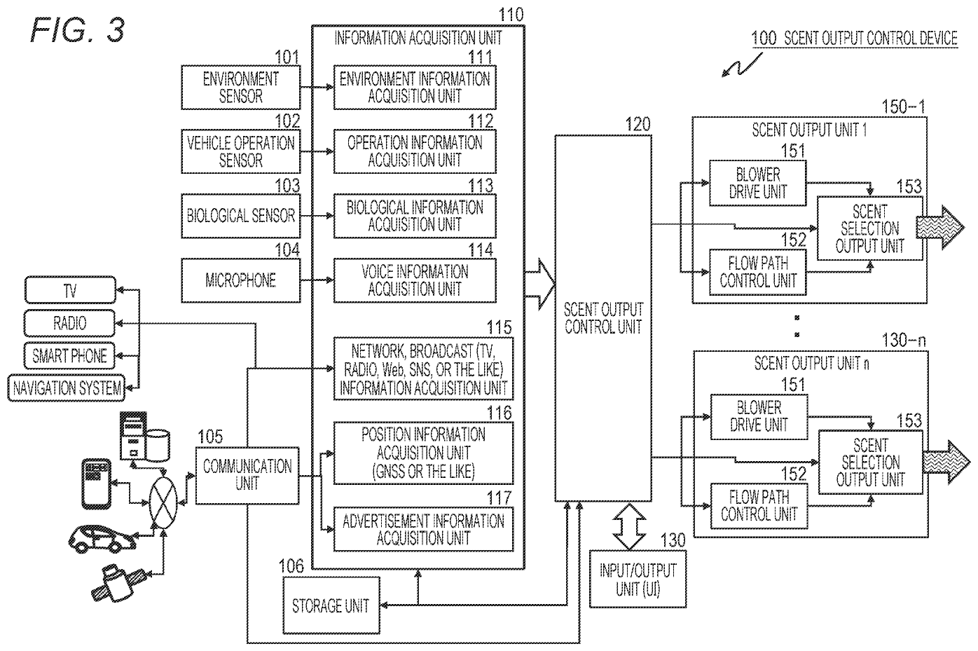

FIG. 3 illustrates a configuration example of the scent output control device of the present disclosure.

As illustrated in FIG. 3, the scent output control device 100 includes an environment sensor 101, a vehicle operation sensor 102, a biological sensor 103, a microphone 104, a communication unit 105, a storage unit 106, an information acquisition unit 110, a scent output control unit 120, an input/output unit (UI) 130, and a scent output unit 150.

The information acquisition unit 110 includes an environment information acquisition unit 111, an operation information acquisition unit 112, a biological information acquisition unit 113, a voice information acquisition unit 114, a network, a broadcast (TV, radio, web, SNS, or the like) information acquisition unit 115, a position information acquisition unit (GNSS) 116, and an advertisement information acquisition unit 117.

The scent output unit 150 includes a blower drive unit 151, a flow path control unit 152, and a scent selection output unit 153.

Note that one or more scent output units 150 are provided.

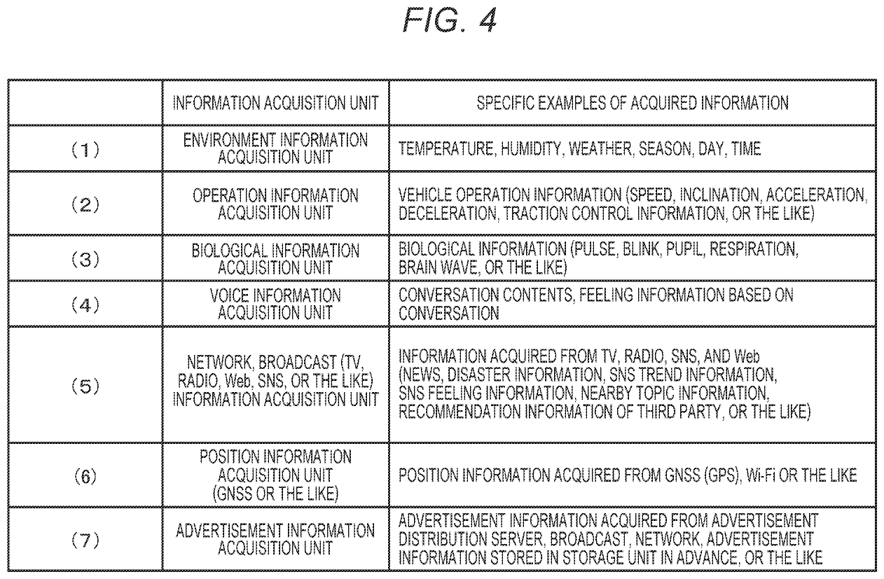

Information acquired by each component of the information acquisition unit 110 will be described with reference to FIG. 4.

FIG. 4 illustrates an example of information acquired by each component of the information acquisition unit 110, that is, the environment information acquisition unit 111, the operation information acquisition unit 112, the biological information acquisition unit 113, the voice information acquisition unit 114, the network, the broadcast (TV, radio, web, SNS, or the like) information acquisition unit 115, the position information acquisition unit (GNSS or the like) 116, and the advertisement information acquisition unit 117.

The environment information acquisition unit 111 receives various types of environment information from the environment sensor 101.

The environment sensor 101 includes, for example, various sensors such as a temperature sensor, a humidity sensor, and a clock. The environment information acquisition unit 111 inputs detection information of these various sensors, and acquires or generates information to be output to the scent output control unit 120 on the basis of the input information.

Specifically, as illustrated in FIG. 4, the environment information acquisition unit 111 acquires information of temperature, humidity, weather, season, day, and time from the input information from the environment sensor 101, or generates the information on the basis of the input information, and outputs the information to the scent output control unit 120.

The operation information acquisition unit 112 receives various types of vehicle operation information from the vehicle operation sensor 102.

The vehicle operation sensor 102 includes, for example, various sensors such as a speed sensor provided in the vehicle and a sensor that detects operation information of an operation unit such as an accelerator, a brake, and a steering. The operation information acquisition unit 112 inputs detection information of these various sensors, and acquires or generates information to be output to the scent output control unit 120 on the basis of the input information.

Specifically, as illustrated in FIG. 4, the operation information acquisition unit 112 acquires vehicle operation information such as speed, inclination, acceleration, deceleration, and traction control information from the input information from the vehicle operation sensor 102, or generates the information on the basis of the input information, and outputs the information to the scent output control unit 120.

The biological information acquisition unit 113 inputs various types of biological information from the biological sensor 103.

The biological sensor 103 includes, for example, various sensors such as a pulse sensor, a respiration sensor, and a pupil sensor. The biological information acquisition unit 113 inputs detection information of these various sensors, and acquires or generates information to be output to the scent output control unit 120 on the basis of the input information.

Specifically, as illustrated in FIG. 4, the biological information acquisition unit 113 acquires biological information such as pulse, blink, pupil, respiration, and brain waves from the input information from the biological sensor 103, or generates the biological information on the basis of the input information, and outputs the biological information to the scent output control unit 120.

The voice information acquisition unit 114 receives various types of voice information from the microphone 104.

The microphone 104 acquires, for example, an utterance of a driver or an occupant of the vehicle. The voice information acquisition unit 114 inputs these pieces of voice information, and acquires or generates information to be output to the scent output control unit 120 on the basis of the input information.

Specifically, as illustrated in FIG. 4, the voice information acquisition unit 114 acquires conversation contents, feeling information based on the conversation, and information from the input information from the microphone 104, or generates the information on the basis of the input information, and outputs the information to the scent output control unit 120.

The network and broadcast (TV, radio, web, SNS, or the like) information acquisition unit 115 inputs various types of information from a television, a radio, a smart phone, a navigation system, an external server, a smart phone, another vehicle, or the like via the communication unit 105.

For example, various information is input from a television, a radio, a smart phone, a navigation system, or a server connected via the communication unit 105, a communication device such as a smart phone, or an external device such as another vehicle used in the vehicle, and information to be output to the scent output control unit 120 is acquired or generated on the basis of the input information.

Specifically, as illustrated in FIG. 4, the network and broadcast (TV, radio, web, SNS, or the like) information acquisition unit 115 acquires and analyzes information acquired from TV, radio, SNS, and web, for example, news, disaster information, SNS trend information, SNS feeling information, nearby topic information, recommendation information of a third party, and the like, and outputs the information to the scent output control unit 120.

The position information acquisition unit 116 inputs, for example, a global navigation satellite system (GNSS/global positioning satellite system) signal or a Wi-Fi signal acquired from a satellite via the communication unit 105, analyzes the current position, and acquires or generates information to be output to the scent output control unit 120.

Specifically, as illustrated in FIG. 4, the position information acquisition unit 116 acquires information such as GNSS (GPS) and Wi-Fi from the input information or generates the information on the basis of the input information, and outputs the information to the scent output control unit 120.

The advertisement information acquisition unit 117 inputs the advertisement information acquired from an advertisement distribution server, broadcast, or network, which is input via the communication unit 105, the advertisement information stored in advance in the storage unit 106, or the like, and acquires or generates information to be output to the scent output control unit 120 on the basis of the input information.

As illustrated in FIG. 4, the advertisement information acquisition unit 117 acquires the advertisement information acquired from the advertisement distribution server, the broadcast, or the network, or the information from the input information, or generates the information on the basis of the input information, and outputs the information to the scent output control unit 120.

The communication unit 105 executes communication with an advertisement distribution server which is an external server, a scent management server, another car, or another communication device (such as a smart phone). Note that the communication information is also input to the scent output control unit 120 in addition to the information acquisition unit 110.

The storage unit 106 is used as a storage area for information acquired by the information acquisition unit 110, for example, various types of information described with reference to FIG. 4, in addition to the map information and the advertisement information. Furthermore, a processing program executed by the scent output control device 100, processing parameters, and the like are also stored.

The input/output unit (UI) 130 includes an input unit for various processing requests by the user, a user interface (UI) as an output unit of information to the user, and the like. Note that specific examples of an information display example and an information input example via the input/output unit (UI) 130 will be described later.

The scent output control unit 120 executes control to output various scents by controlling the scent output units 150-1 to n on the basis of various information input from the information acquisition unit 110, user instruction information input via the input/output unit (UI) 130, and the like.

The scent output control unit 125 controls each of the blower control unit 151, the flow path control unit 152, and the scent selection output unit 153 in each scent output unit 150 to execute selection processing of a type of scents to be output, control of output intensity and output time of the scent to be output, an output flow path of the scent, and the like.

For example, the scent selection output unit 153 executes control to select one from a large number of cartridges storing various different scents and output the scent of the cartridge into the vehicle.

[2. For Configuration of Scent Output Control Unit and Processing Executed]

Next, the configuration of the scent output control unit 120 of the scent output control device 100 illustrated in FIG. 3 and the process to be performed will be described.

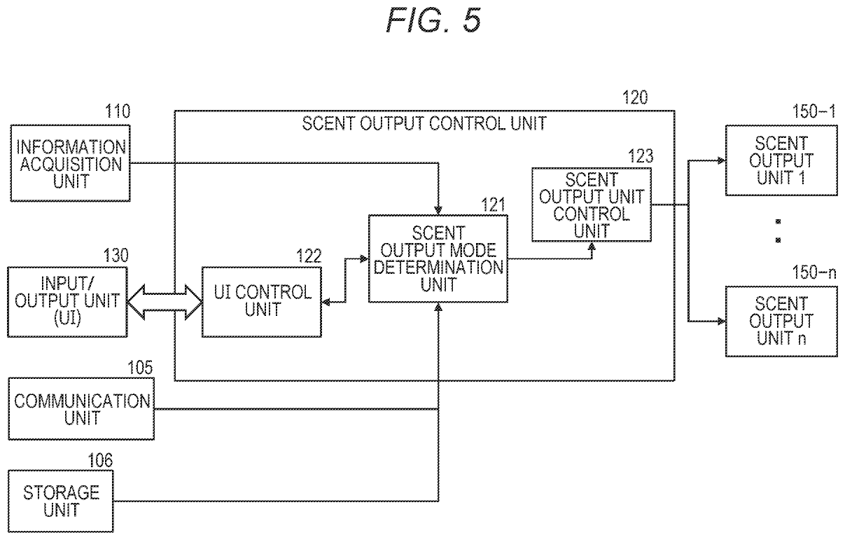

FIG. 5 is a diagram illustrating a detailed configuration example of the scent output control unit 120 of the scent output control device 100. This will be described.

As illustrated in FIG. 5, the scent output control unit 120 includes a scent output mode determination unit 121, a UI control unit 122, and a scent output unit control unit 134.

The scent output mode determination unit 121 determines the scent output mode on the basis of input information from the information acquisition unit 110, user setting information input via the UI control unit 122, and the like.

As described above with reference to FIG. 3, the information acquisition unit 110 includes the environment information acquisition unit 111, the operation information acquisition unit 112, the biological information acquisition unit 113, the voice information acquisition unit 114, the network, the broadcast (TV, radio, web, SNS, etc.) information acquisition unit 115, the position information acquisition unit (GNSS or the like) 116, the advertisement information acquisition unit 117, and these information acquisition units.

The scent output mode determination unit 121 determines the scent output mode on the basis of information input from each of these components, the user setting information input via the UI control unit 122, and the like.

The UI control unit 122 generates display information to be presented to the user, outputs the display information to the input/output unit (UI) 130, and analyzes the user input to the input/output unit (UI) 130. The analysis information is input to the scent output mode determination unit 121.

The scent output unit control unit 123 controls the scent output unit 150 according to the scent output mode determined by the scent output mode determination unit 121 to output various scents from the scent output unit 150.

Note that, as described above with reference to FIG. 3, each of the scent output units 150 includes the blower drive unit 151, the flow path control unit 152, and the scent selection output unit 153, and the scent output unit control unit 123 inputs a control signal to each of these components of the scent output unit 150 to execute the type selection and output control of the scent to be output.

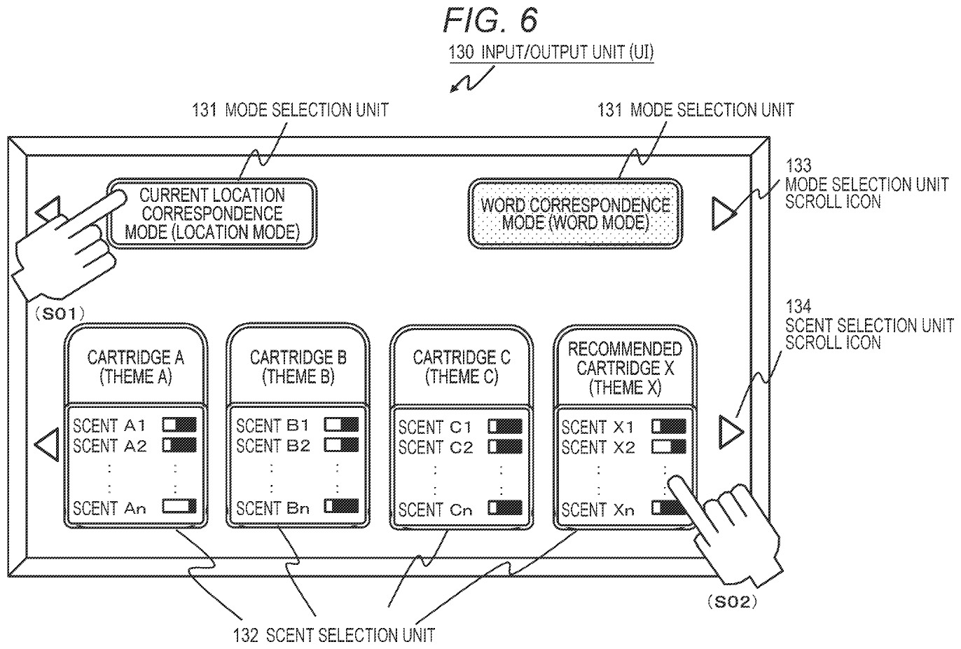

Next, an example of information presented to the user by the UI control unit 122 will be described with reference to FIG. 6.

FIG. 6 is a diagram illustrating an example of UI data displayed on the display unit constituting the input/output unit (UI) 130, that is, information presented to the user by the UI control unit 122.

As illustrated in FIG. 5, the UI control unit 122 displays, as display data, display data including a mode selection unit 131, a scent selection unit 132, a mode selection unit scroll icon 133, a scent selection unit scroll icon 134, and the like on the input/output unit (UI) 130.

The mode selection unit 131 is a mode selection unit that can select various modes such as a “current location correspondence mode (location mode)” and a “word correspondence mode (word mode)”.

By touching the mode selection unit scroll icon 133, various mode selection units are displayed on the display unit, and the user can select the touched mode by touching one of the displayed mode selection units.

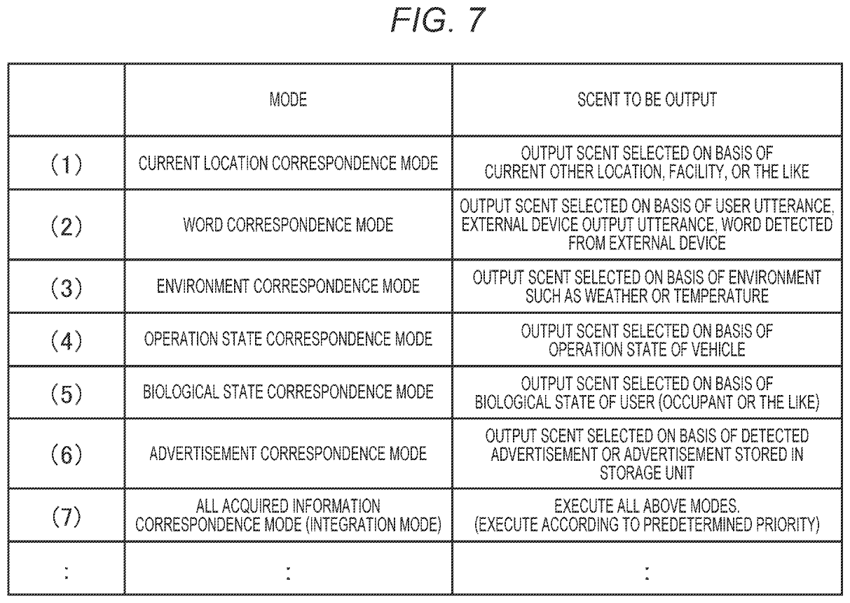

An example of modes that can be set in the scent output control device 100 of the present disclosure and a specific example of a scent output mode in each mode will be described with reference to FIG. 7.

As illustrated in FIG. 7, there are, for example, the following modes as modes that can be set in the scent output control device 100 of the present disclosure.

(1) Current location correspondence mode

(2) Word correspondence mode

(3) Environment correspondence mode

(4) Operation state correspondence mode

(5) Biological state correspondence mode

(6) Advertisement correspondence mode

(7) All acquired information correspondence mode

(1) The current correspondence mode is a mode for outputting a scent corresponding to the current location of the vehicle equipped with the scent output control device 100. Specifically, for example, the mode is a mode for outputting a scent selected on the basis of the current position acquired by the position information acquisition unit 116, a facility at the current position, or the like.

(2) The word correspondence mode is a mode for outputting a scent selected on the basis of an utterance of an occupant of a vehicle equipped with the scent output control device 100, an utterance or music output from a device such as a television, a radio, or a smart phone, an input/output word of a navigation system, an input/output word of a network connection device, for example, a word that is a topic in an SNS, or the like.

For example, the scent selection processing is executed on the basis of the acquisition information of the voice information acquisition unit 114, the network, and the broadcast information acquisition unit 115.

(3) The environmental correspondence mode is a mode for outputting a scent selected on the basis of the external environment of the vehicle equipped with the scent output control device 100, for example, weather, temperature, or the like.

For example, the scent selection processing is performed on the basis of the information acquired by the environment information acquisition unit 111.

(4) The operation state correspondence mode is a mode for outputting a scent selected on the basis of the operation state of the vehicle equipped with the scent output control device 100.

For example, the scent selection processing is performed on the basis of the information acquired by the operation information acquisition unit 113.

(5) The biological state correspondence mode is a mode for outputting a scent selected on the basis of the biological state of the occupant of the vehicle equipped with the scent output control device 100.

For example, the scent selection processing is performed on the basis of the information acquired by the biological information acquisition unit 114.

(6) The advertisement support mode is a mode for outputting an advertisement detected from an exterior advertisement, a device such as a television, a radio, or a smart phone, or a scent selected on the basis of an advertisement information recorded in advance in a storage unit.

(7) The all acquisition information correspondence mode is a mode for executing all of the modes (1) to (6) described above. In order to prevent different scents from being selected temporally redundantly in different modes, priority is set in advance in the execution order of the modes, and the selected scent is preferentially output in a mode with a higher priority.

Note that, after selecting one mode selection unit 131 on the display screen of the input/output unit (UI) 130 illustrated in FIG. 6, the user can further select one scent from the scent selection unit 132 at the bottom of the screen.

The scent selection unit 132 displays a plurality of different scent output candidates selected according to the mode selected by the user.

The scent selection unit scroll icon 134 is also displayed on the left and right of the scent selection unit 132, and in a case where there are a large number of scent output candidates, by touching this scroll icon, a large number of scent output candidates can be displayed in sequence.

Each of the scent output candidates displayed in the scent selection unit 132 corresponds to one scent cartridge, and the scent component information included in each scent cartridge and the remaining amount information of each scent component are displayed together.

The user can also check the remaining amount display to determine whether or not replacement of the cartridge is necessary.

The user touches one scent selected from a plurality of scent output candidates displayed on the scent selection unit 132. The user selection information by this touch is input to the scent output mode determination unit 121 via the UI control unit 122.

The scent output mode determination unit 121 notifies the scent output unit control unit 123 of the scent selected by the user, and the scent output unit control unit 123 controls the scent output unit 150 to output the scent selected by the user.

Note that, in a case where the selection by the user has not been executed within the specified time, a cartridge having a predetermined high priority order, for example, a recommended cartridge at the right end illustrated in FIG. 6 is selected as the usage cartridge.

[3. For Specific Example of Scent Output Control Executed by Scent Output Control Device of the Present Disclosure]

Next, a specific example of the scent output control executed by the scent output control device 100 of the present disclosure will be described.

Hereinafter, specific examples of the scent output control when the following two modes are set will be described

(1) Current location correspondence mode

(2) Word correspondence mode

(3-(1) for Example of Scent Output Control in Current Location Corresponding Mode)

First, an example of scent output control in the current location correspondence mode will be described.

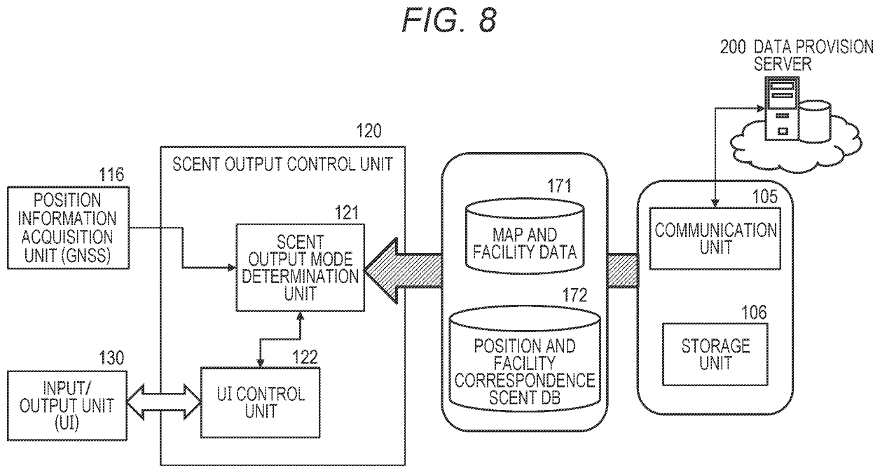

FIG. 8 is a diagram for describing processing executed by the scent output control unit 120 in a case where the mode setting of the scent output control device 100 of the present disclosure is the current location correspondence mode.

In the current location correspondence mode, the scent output mode determination unit 121 of the scent output control unit 120 inputs the current location information of the vehicle from the position information acquisition unit 116 of the information acquisition unit 110.

The scent output mode determination unit 121 of the scent output control unit 120 further acquires a map, facility data 171, a position and facility correspondence scent database 172 from the data provision server 200 or the storage unit 106 connected via the communication unit 105.

The map and facility data 171 are data in which map information and facility information are recorded, and the scent output control unit 120 can check the current location on the map, nearby facility information, and the like on the basis of the current vehicle location information input from the position information acquisition unit 116.

In the position and facility correspondence scent database 172, optimum scent output candidates corresponding to the position on the map and the facility, scent output mode information, and the like are recorded.

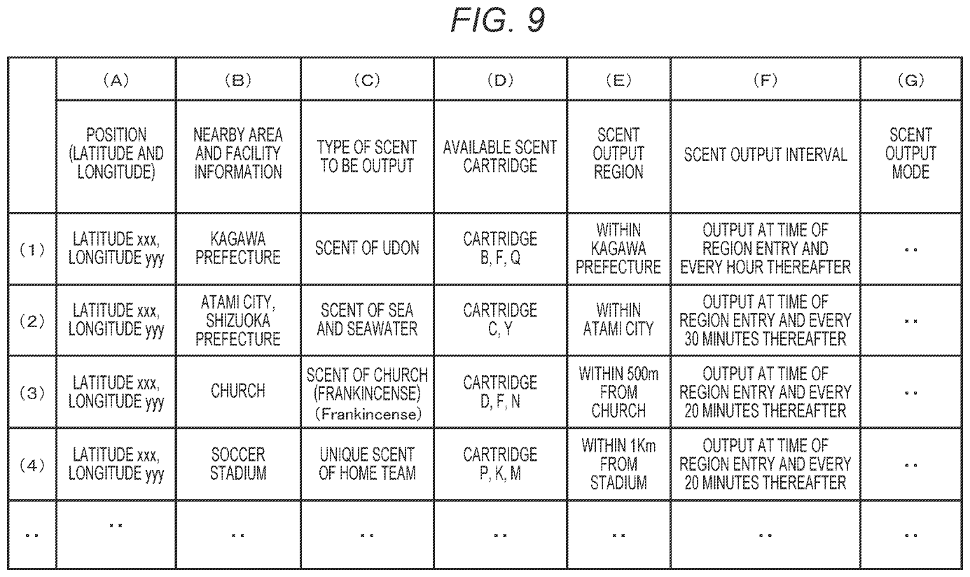

A specific example of the record data of the position and facility correspondence scent database 172 will be described with reference to FIG. 9.

As illustrated in FIG. 9, the following data are recorded in association with each other in the position and facility correspondence scent database 172.

(A) Position (latitude, longitude)

(B) Nearby area and facility information

(C) Type of scent to be output

(D) Scent cartridge to be used

(E) Scent output region

(F) Scent output interval

(G) Scent output mode

Note that the user can freely change the registration information. For example, the type of the scent to be output, the cartridge to be used, the scent output region, the interval, the mode, and the like can be changed according to the user's preference.

(A) The position (latitude, longitude) is used, for example, as collation data with the current position information of the vehicle input from the position information acquisition unit 116.

The scent output mode determination unit 121 of the scent output control unit 120 selects an entry in which position information closest to the current position information of the vehicle input from the position information acquisition unit 116 is recorded, and performs presentation processing of UI information and scent output control according to the information recorded in the selected entry.

Note that various types of scent output mode information corresponding to each entry are recorded in the (G) scent output mode.

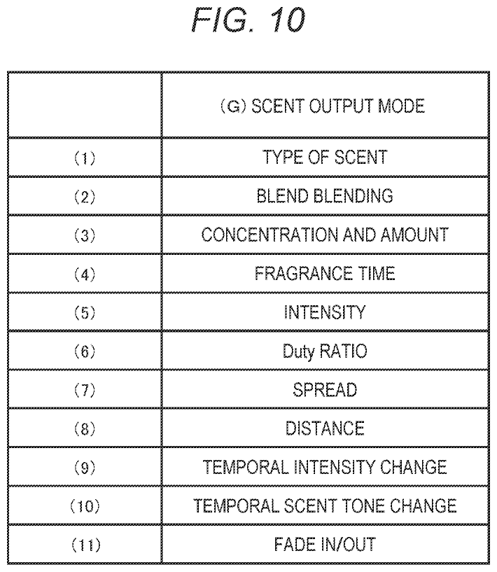

(G) A specific example of the type of record data of the scent output mode is illustrated in FIG. 10.

As illustrated in FIG. 10, in the (G) scent output mode, the following information is recorded as various types of scent output mode information corresponding to each entry.

(1) Type of scent, (2) blend formulation, (3) concentration, amount, (4) direction time, (5) strength, (6) duty ratio, (7) spread, (8) distance, (9) temporal intensity change, (10) temporal scent tone change, (11) fade IN/OUT

These data are various data for determining the output mode of the scent, and these data are set and recorded in advance for each entry.

For example, in a case where the entry in which the position information closest to the current position information of the vehicle input from the position information acquisition unit 116 is recorded is the entry (1), the presentation processing of the UI information and the scent output control are performed according to the information recorded in the entry (1).

Information of (B) to (F) of the entry (1) is as follows.

(B) Nearby area, facility information=Near Kagawa prefecture

(C) Type of scent to be output=Scent of noodles

(D) Scent cartridge to be used=Cartridges B, F, and Q

(E) Scent output region=Within Kagawa prefecture

(F) Scent output interval=Output at the time of region entry and every hour thereafter

The scent output mode determination unit 121 of the scent output control unit 120 determines that the nearby area of the current location is in Kagawa Prefecture, on the basis of the registration data of entry (1) having recorded therein (A) location information that is closest to the current location information of the vehicle input from the position information acquisition unit 116.

Further, it is determined on the basis of the registration data that the scent to be output is the scent of the noodles and the cartridges B, F, and Q are the optimum cartridges for outputting the scent of the noodles.

The scent output mode determination unit 121 notifies the UI control unit 122 of the registered cartridge information of the cartridges B, F, and Q.

The UI control unit 122 outputs the list data in which the cartridges B, F, and Q are set as the scent selection candidates to the scent selection unit 132 display area, which is the configuration data of the UI data described above with reference to FIG. 6.

The user can select a scent to be output from the cartridges B, F, and Q including a scent similar to a scent of Japanese wheat noodles.

The scent output mode determination unit 121 of the scent output control unit 120 determines the selected cartridge as a used cartridge according to user selection information input via the UI control unit 122, and notifies the scent output unit control unit 123 of the selected cartridge information.

Furthermore, the scent output mode determination unit 121 determines the following information registered in the position and facility correspondence scent database 172:

(E) Scent output region=within Kagawa prefecture

(F) Scent output interval=Output at the time of region entry and every hour thereafter

(G) Scent output mode

These pieces of information are also notified to the scent output unit control unit 123.

The scent output unit control unit 123 applies the input information from the scent output mode determination unit 121, that is, the type (identifier) of the cartridge to be used and each of the information (E) to (G) above, and executes the scent output control according to each of the information (E) to (G) above.

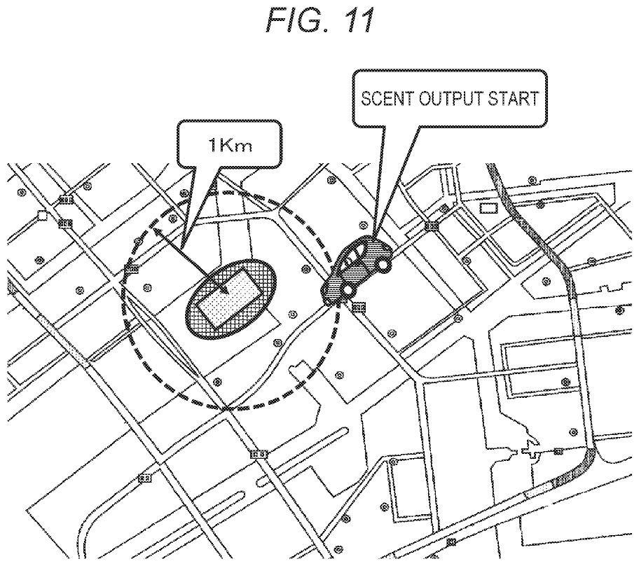

Next, a processing example in a case where the processing to which the entry (4) illustrated in FIG. 9 is applied is performed will be described with reference to FIG. 11. As illustrated in FIG. 11, this is an example in which the scent output of the scent cartridge selected by the user is executed in a stage where the vehicle enters an area within 1 Km from the soccer stadium.

Entry (4) illustrated in FIG. 9 is an entry applied when a vehicle equipped with the scent output control device 100 of the present disclosure is approaching a soccer stadium.

The registration data of the entry (4) of the data of FIG. 9 is

(D) Cartridges P, K, M

(E) Scent output region=1 Km from stadium

(F) Scent output interval=Output at the time of region entry and every 20 minutes thereafter

These are the registration data.

The scent output mode determination unit 121 first notifies the UI control unit 122 of the registered cartridge information of the cartridges P, K, and M.

The UI control unit 122 outputs the list data in which the cartridges P, K, and M are set as the scent selection candidates to the scent selection unit 132 display area, which is the configuration data of the UI data described above with reference to FIG. 6.

The user selects the scent to be output

The scent output mode determination unit 121 of the scent output control unit 120 determines the selected cartridge as a used cartridge according to user selection information input via the UI control unit 122, and notifies the scent output unit control unit 123 of the selected cartridge information.

Furthermore, the scent output mode determination unit 121 determines the following information registered in the position and facility correspondence scent database 172:

(E) Scent output region=1 Km from stadium

(F) Scent output interval=Output at the time of region entry and every 20 minutes thereafter

(G) Scent output mode

These pieces of information are also notified to the scent output unit control unit 123.

The scent output unit control unit 123 applies the input information from the scent output mode determination unit 121, that is, the type (identifier) of the cartridge to be used and each of the information (E) to (G) above, and executes the scent output control according to each of the information (E) to (G) above.

Specifically, as illustrated in FIG. 11, the scent output of the scent cartridge selected by the user is executed in a stage where the vehicle enters an area within 1 Km from the soccer stadium. Furthermore, the scent output is then performed every 20 minutes.

With such control, the user, that is, the occupant of the vehicle can know that the vehicle is approaching a soccer stadium on the basis of the scent.

(3-(2) for Example of Scent Output Control in Word Correspondence Mode)

Next, a scent output control example in the word correspondence mode will be described.

As described above with reference to FIG. 7, the word correspondence mode is a mode for outputting a scent selected on the basis of an utterance of an occupant of a vehicle equipped with the scent output control device 100, an utterance or music output from a device such as a television, a radio, or a smart phone, and a word of a network connection device, for example, a word that is a topic in an SNS, or the like.

For example, the scent selection processing is executed on the basis of the acquisition information of the voice information acquisition unit 114, the network, and the broadcast information acquisition unit 115.

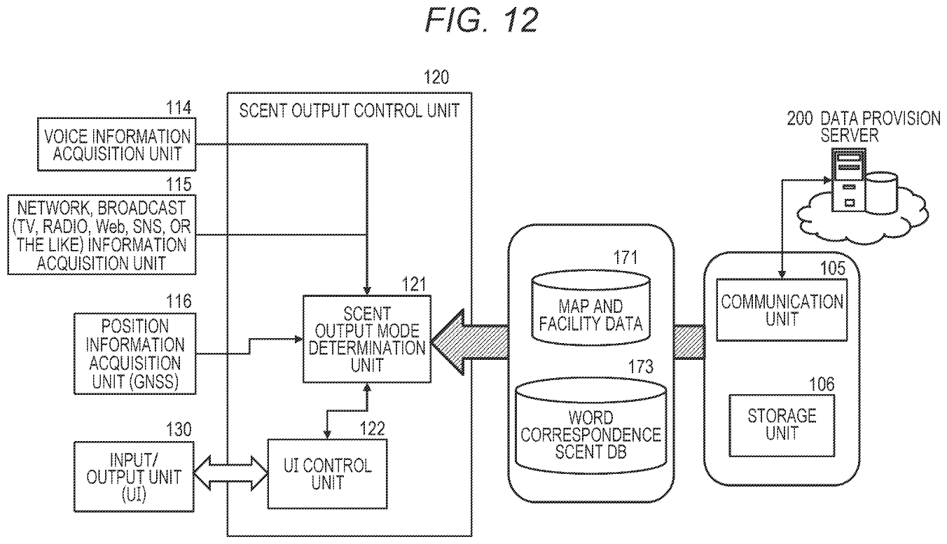

FIG. 12 is a diagram for describing processing executed by the scent output control unit 120 in a case where the mode setting of the scent output control device 100 of the present disclosure is the word correspondence mode.

In the case of the word correspondence mode, the scent output mode determination unit 121 of the scent output control unit 120 inputs, from the voice information acquisition unit 114, the network, or the broadcast information acquisition unit 115 of the information acquisition unit 110, information such as an utterance of an occupant of the vehicle equipped with the scent output control device 100, an utterance or music output from devices such as the television, the radio, or the smart phone, and a word of a network connection device, for example, a word that is a topic in an SNS, or the like.

The scent output mode determination unit 121 of the scent output control unit 120 further acquires a map, facility data 171, a position, and a word correspondence scent database 173 from the data provision server 200 or the storage unit 106 connected via the communication unit 105.

The map and facility data 171 are data in which map information and facility information are recorded, and the scent output control unit 120 can check the current location on the map, nearby facility information, and the like on the basis of the current vehicle location information input from the position information acquisition unit 116.

The word correspondence scent database 173 is data in which an utterance of an occupant of the vehicle, an utterance output from a device such as a television, a radio, or a smart phone, a word included in music, an optimal scent output candidate corresponding to a word of a network connection device, for example, a word that is a topic in an SNS, scent output mode information, and the like are recorded.

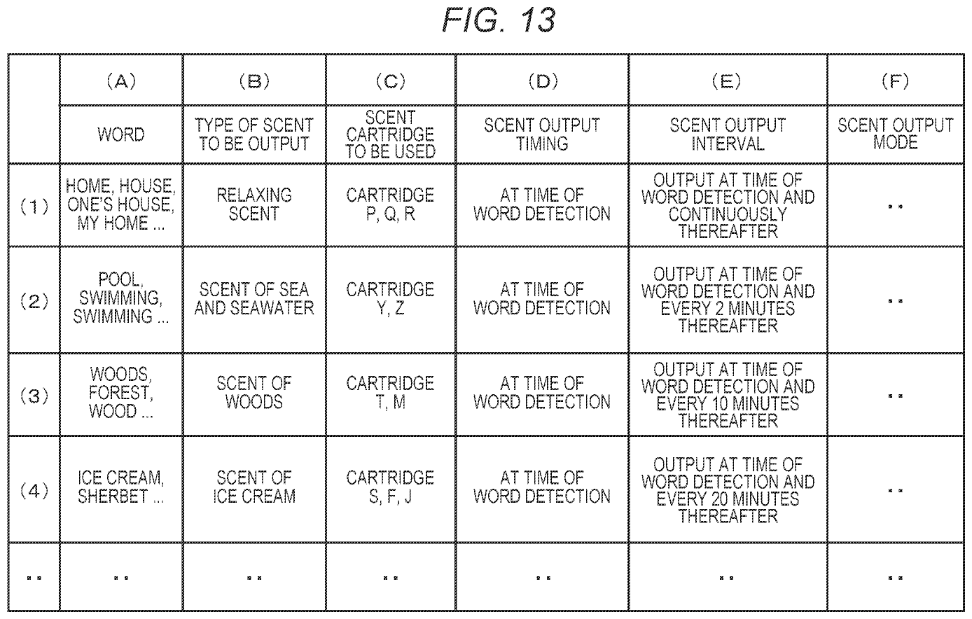

A specific example of the record data of the word correspondence scent database 173 will be described with reference to FIG. 13.

As illustrated in FIG. 13, the following data are recorded in the word correspondence scent database 173 in association with each other.

(A) Word

(B) Type of scent to be output

(C) Scent cartridge to be used

(D) Scent output timing, region,

(E) Scent output interval

(F) Scent output mode

Note that the user can freely change the registration information. For example, the type of the scent to be output, the cartridge to be used, the scent output timing, the region, the interval, the mode, and the like can be changed according to the user's preference.

(A) The word is used, for example, as collation data with a word input from the voice information acquisition unit 114, the network, or the broadcast information acquisition unit 115, that is, a word included in utterance of an occupant of the vehicle, utterance output from a device such as a television, a radio, or a smart phone, or music, and a word of a network connection device, for example, a word that is a topic in an SNS, or the like.

The scent output mode determination unit 121 of the scent output control unit 120 selects an entry in which a word closest to the input word is recorded, and performs presentation processing of UI information and scent output control according to the information recorded in the selected entry.

Note that, in the (G) scent output mode, various types of scent output mode information corresponding to each entry are recorded, and the following information described above with reference to FIG. 10 is recorded:

(1) Type of scent, (2) blend formulation, (3) concentration, amount, (4) direction time, (5) strength, (6) duty ratio, (7) spread, (8) distance, (9) temporal intensity change, (10) temporal scent tone change, (11) fade IN/OUT

These data are various data for determining the output mode of the scent, and these data are set and recorded in advance for each entry.

For example, in a case where the entry in which the word closest to the word input from the voice information acquisition unit 114, the network, or the broadcast information acquisition unit 115 is recorded is the entry (1), the presentation processing of the UI information and the scent output control are performed according to the information recorded in the entry (1).

Information of (A) to (F) of the entry (1) is as follows.

(A) Word=Home, house, one's house, my home

(B) Type of scent to be output=relaxing scent

(C) Scent cartridge to be used=cartridges P, Q, R

(D) Scent output region=at the time of word detection

(E) Scent output interval=at the time of word detection and thereafter continuous output

The scent output mode determination unit 121 of the scent output control unit 120 executes processing of setting UI output information, processing of determining a scent to be output, and the like, on the basis of the registration data of the entry (1) in which the word (A) closest to the word input from the voice information acquisition unit 114, the network, or the broadcast information acquisition unit 115 is recorded.

First, on the basis of the registration data of the entry (1), it is determined on the basis of the registration data that the scent to be output is a relaxing scent and the cartridges P, Q, and R are the most suitable cartridges for outputting this scent.

The scent output mode determination unit 121 notifies the UI control unit 122 of the registered cartridge information of the cartridges P, Q, and R.

The UI control unit 122 outputs the list data in which the cartridges P, Q, and R are set as the scent selection candidates to the scent selection unit 132 display area, which is the configuration data of the UI data described above with reference to FIG. 6.

The user can select a scent to be output from the cartridges P, Q, and R having a relaxing scent.

The scent output mode determination unit 121 of the scent output control unit 120 determines the selected cartridge as a used cartridge according to user selection information input via the UI control unit 122, and notifies the scent output unit control unit 123 of the selected cartridge information.

Furthermore, the scent output mode determination unit 121 stores the following information registered in the word correspondence scent database 173:

(D) Scent output region=at the time of word detection

(E) Scent output interval=at the time of word detection and thereafter continuous output

(F) Scent output mode

The scent output unit control unit 123 is notified of these pieces of information as well.

The scent output unit control unit 123 applies the input information from the scent output mode determination unit 121, that is, the type (identifier) of the cartridge to be used and each of the information (D) to (F) above, and executes the scent output control according to each of the information (D) to (F) above.

Note that, referring to FIGS. 8 to 13,

(1) Current location correspondence mode

(2) Word correspondence mode specific examples of the above two modes have been described, but as described above, there are, for example, the following modes as modes that can be set in the scent output control device 100 of the present disclosure:

(1) Current location correspondence mode

(2) Word correspondence mode

(3) Environment correspondence mode

(4) Operation state correspondence mode

(5) Biological state correspondence mode

(6) Advertisement correspondence mode

(7) All acquired information correspondence mode

The output mode determination unit 121 of the scent output control unit 120 of the scent output scent output control device 100 of the present disclosure acquires the usage cartridge information, the scent output mode information, and the like corresponding to each mode from the database using different scent databases according to each mode, and performs control according to the acquired information.

(3) In a case where the mode is set to the environment-compatible mode, processing is executed with reference to registration data of an environment-compatible scent database in which a type of a scent associated with temperature, weather, season, or the like, a scent cartridge to be used, a scent output timing, a region, an interval, and a scent output mode are registered.

(4) In a case where the operation state correspondence mode is set, processing is executed with reference to the registration data of the vehicle operation correspondence scent database in which the type of scent associated with the vehicle operation, the scent cartridge to be used, the scent output timing, the region, the interval, and the scent output mode, such as start, stop, acceleration, deceleration, and curve, are registered.

(5) In a case where the biological state correspondence mode is set, the processing is executed with reference to the registration data of the biological information correspondence scent database in which the type of scent associated with the heartbeat, the pupil, and the like, the scent cartridge to be used, the scent output timing, the region, the interval, and the scent output mode of the occupant are registered.

(6) In a case where the advertisement correspondence mode is set, processing is executed with reference to registration data of an advertisement correspondence scent database in which a type of a scent associated with an advertisement content or the like, a scent cartridge to be used, a scent output timing, a region, an interval, and a scent output mode are registered.

As described above, the scent output control device of the present disclosure switches and uses the mode-correspondence scent database to be used according to the setting mode. The scent output control device of the present disclosure selects a scent cartridge registered in the selected mode-correspondence scent database in association with information acquired according to each mode, and executes presentation processing of UI information and scent output control.

[4. For Configuration Example of Executing Scent Output Mode Determination Processing in External Server]

Next, a configuration example in which the scent output mode determination process is executed in the external server will be described.

The scent output control device 100 described with reference to FIGS. 1 to 13 has executed UI output information setting processing, output scent determination processing, and the like, on the basis of input information from each of the components of the information acquisition unit 110, that is, the environment information acquisition unit 111, the operation information acquisition unit 112, the biological information acquisition unit 113, the voice information acquisition unit 114, the network, the broadcast (TV, radio, web, SNS, or the like) information acquisition unit 115, the position information acquisition unit (GLASS) 116, and the advertisement information acquisition unit 117.

The setting processing of the UI output information and the determination processing of the scent to be output may be executed in an external server.

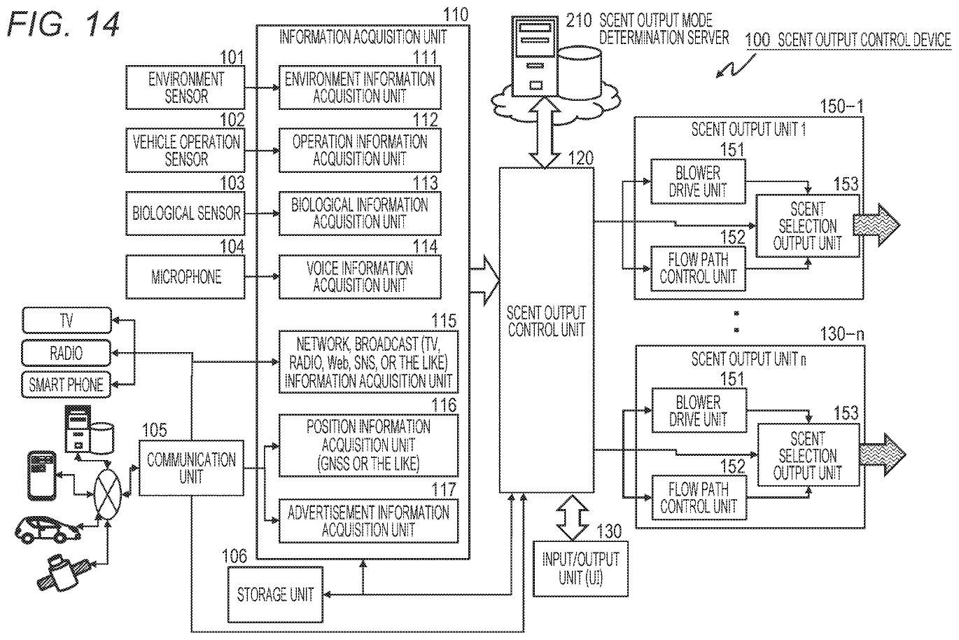

For example, as illustrated in FIG. 14, the scent output control unit 120 communicates with an external server, that is, the scent output mode determination server 210 illustrated in FIG. 14, receives the UI output information determined by the scent output mode determination server 210 and the determination information of the scent to be output from the scent output mode determination server 210, and executes the UI output and the scent output control.

The scent output control device 100 selects information to be used for scent selection from the information acquired by the information acquisition unit 110 according to a preset mode, and transmits the selected information to the scent output mode determination server 210.

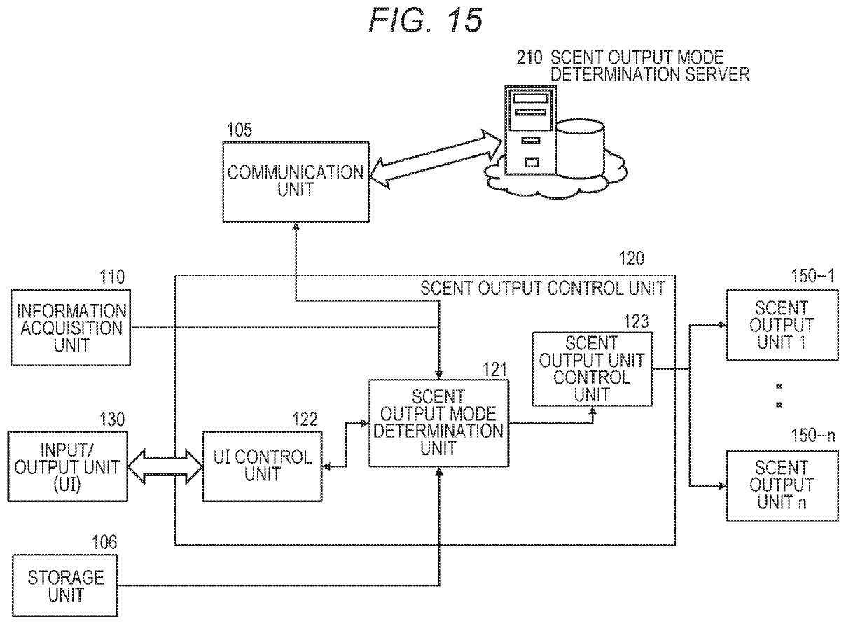

The processing of the present embodiment will be described with reference to FIG. 15.

FIG. 15 illustrates the configuration of the scent output control unit 120 and the scent output determination server 210.

First, the scent output mode determination unit 121 of the scent output control unit 120 inputs information from the information acquisition unit 110. Specifically, the information from any one of the environment information acquisition unit 111, the operation information acquisition unit 112, the biological information acquisition unit 113, the voice information acquisition unit 114, the network, the broadcast (TV, radio, web, SNS, or the like) information acquisition unit 115, the position information acquisition unit (GNSS) 116, and the advertisement information acquisition unit 117 is input.

The scent output mode determination unit 121 transmits the input information from the information acquisition unit 110 to the scent output mode determination server 210 via the communication unit 105.

Note that the scent output mode determination unit 121 of the scent output control device 100 selects information to be used for scent selection from the information acquired by the information acquisition unit 110 according to a preset mode, and transmits the selected acquisition information and setting mode information to the scent output mode determination server 210.

The scent output mode determination server 210 holds the map, the facility data 171, the location, and the facility correspondence management database 172 described above with reference to FIGS. 8 and 9, and further holds the word correspondence scent database stolen and the scent database corresponding to each mode described above with reference to FIGS. 12 and 13.

That is, it is a scent database corresponding to each mode in which a type of a scent corresponding to each mode, a scent cartridge to be used, a scent output timing, a region, an interval, and a scent output mode are registered.

(1) Current location correspondence mode

(2) Word correspondence mode

(3) Environment correspondence mode

(4) Operation state correspondence mode

(5) Biological state correspondence mode

(6) Advertisement correspondence mode

When the input information from the information acquisition unit 110 is input from the scent output mode determination unit 121 of the scent output control unit 120, the scent output mode determination server 210 refers to the mode-correspondence scent database to acquire the type of scent corresponding to each mode, the scent cartridge to be used, the scent output timing, the region, the interval, and the scent output mode information, and transmits the acquired information to the scent output mode determination unit 121 of the scent output control device 100.

The scent output mode determination unit 121 determines UI output information on the basis of the information received from the scent output mode determination server 210, and outputs the UI output information to the input/output unit (UI) 130 via the UI control unit 122. Furthermore, the use cartridge is determined on the basis of the user selection information input to the input/output unit (UI) 130, notification of the scent output control mode is provided to the scent output unit control unit 124 on the basis of the information received from the scent output mode determination server 210, and the scent output control is executed.

As described above, in the scent output mode determination server 210, the UI output information and the process of determining the control mode of the scent to be output are executed, so that the processing load of the scent output control device 100 can be reduced, and the data to be held can also be reduced. That is, it is not necessary to hold the scent database corresponding to each mode, and the storage capacity of the storage unit can be reduced.

[5. For Sequence of Processing Executed by Scent Output Control Device of the Present Disclosure]

Next, a sequence of processing executed by the scent output control device 100 of the present disclosure will be described.

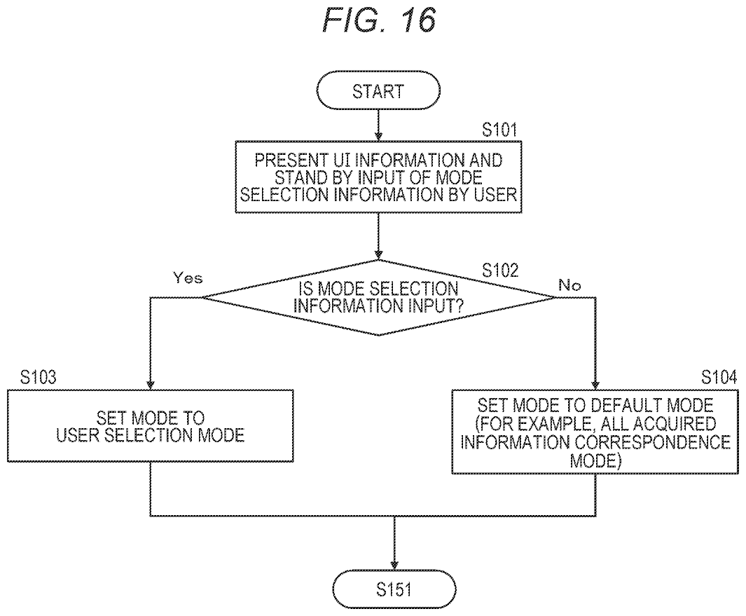

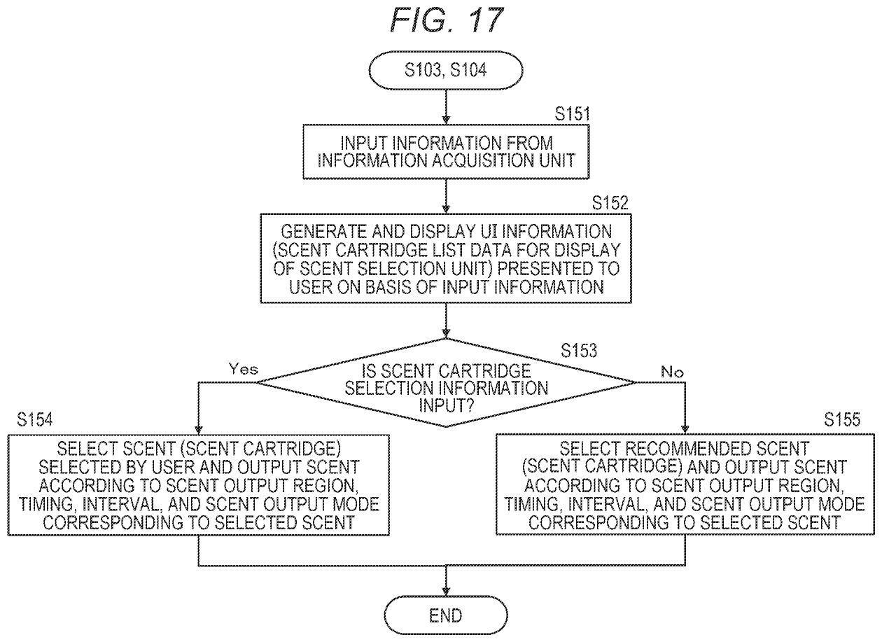

A sequence of processing executed by the scent output control device 100 of the present disclosure will be described with reference to the flowcharts illustrated in FIGS. 16 and 17.

The processing according to the flow illustrated in FIGS. 16 and 17 is, for example, processing that can be executed under the control of a CPU or the like having a program execution function according to a program stored in a storage unit of the scent output control device 100, and can be executed under the control of a data processing unit of the scent output control device 100 of the present disclosure, that is, a data processing unit having a CPU having a program execution function.

The processing of each step of the flow illustrated in FIGS. 16 to 17 will be sequentially described.

(Step S101)

First, in step S101, the scent output control unit 120 of the scent output control device 100 presents UI information to the user and waits for the user to input mode selection information.

Note that the modes that can be set in the scent output control device 100 of the present disclosure are, for example, the following modes described above with reference to FIG. 7.

(1) Current location correspondence mode

(2) Word correspondence mode

(3) Environment correspondence mode

(4) Operation state correspondence mode

(5) Biological state correspondence mode

(6) Advertisement correspondence mode

(7) All acquired information correspondence mode

The scent output control unit 120 of the scent output control device 100 displays the UI information described earlier with reference to FIG. 6 on the input/output unit (UI) 130. That is, the mode selection unit 131 is displayed in the upper region of the display unit. The mode selection unit 131 can scroll by touching the mode selection unit scroll icon 133, and the user can select any one of the modes (1) to (7).

(Step S102)

Next, in step S102, the scent output control unit 120 determines whether or not the mode selection information has been input by the user within a predefined time period.

When the input of the mode selection information by the user is confirmed within the predetermined time, the process proceeds to step S103.

On the other hand, in a case where the input of the mode selection information by the user has not been confirmed within the predetermined time, the process proceeds to step S104.

(Step S103)

In step S102, when the input of the mode selection information by the user is confirmed within the predetermined time, the process proceeds to step S103.

In this case, the scent output control unit 120 sets the mode to the user selection mode in step S103.

(Step S104)

On the other hand, in step S102, in a case where the input of the mode selection information by the user is not confirmed within the predetermined time, the process proceeds to step S104.

In this case, in step S104, the scent output control unit 120 sets the mode to the default setting mode, for example, the all-acquisition information correspondence mode.

As described above, the all-acquisition information correspondence mode is a mode in which all the modes (1) to (6) described above are executed. In order to prevent different scents from being selected temporally redundantly in different modes, priority is set in advance in the execution order of the modes, and the selected scent is preferentially output in a mode with a higher priority.

When the mode setting is completed by the processing in step S103 or step S104, the process proceeds to step S151.

(Step S151)

Next, in step S105, the scent output control unit 120 inputs information from the information acquisition unit 110.

In step S105, the scent output control unit 120 inputs information from the components of the information acquisition unit 110, that is, the environment information acquisition unit 111, the operation information acquisition unit 112, the biological information acquisition unit 113, the voice information acquisition unit 114, the internet, the broadcast (TV, radio, web, SNS, or the like) information acquisition unit 115, the position information acquisition unit (GNSS) 116, and the advertisement information acquisition unit 117.

(Step S152)

Next, in step S152, the scent output control unit 120 selects a scent database to be referenced on the basis of the information input from the information acquisition unit 110 in step S151 and the setting mode. Further, the scent cartridge list data for scent selection unit display to be displayed on the input/output unit (UI) 130 is generated and displayed with reference to the selected scent database.

That is, the scent cartridge list data to be displayed in the scent selection unit 132 to be displayed in the input/output unit (UI) 130 described above with reference to FIG. 6 is generated and displayed.

Note that the scent cartridge to be displayed is acquired from the scent database corresponding to the mode.

For example, when the mode is the “current location correspondence mode”, the identifier of the scent cartridge to be displayed is acquired from the record data of the position and facility correspondence scent database 172 having the data configuration described above with reference to FIG. 9.

First, an entry in which “(A) position information” closest to the current position information input from the position information acquisition unit 116 of the information acquisition unit 110 is registered is selected from the position, facility correspondence scent database 172. Next, the cartridge identifier registered in “(D) the available scent cartridge” of the selected entry is selected, and the cartridge list data including the contents of the selected cartridge is generated and displayed.

Note that as described above with reference to FIG. 6, the cartridge list data displayed on the input/output unit (UI) 130 includes the scent component information included in each scent cartridge and the remaining amount information for each scent component.

(Step S153)

Next, in step S153, the scent output control unit 120 determines whether or not user selection information for the displayed scent cartridge list data has been input within the prescribed time.

In a case where the user selection information for the displayed scent cartridge list data has been input within the prescribed time, the process proceeds to step S154.

On the other hand, when the user selection information for the displayed scent cartridge list data has not been input within the prescribed time, the process proceeds to step S155.

(Step S154)

In step S153, when the user selection information for the displayed scent cartridge list data is input within the prescribed time, the process proceeds to step S154.

In this case, in step S154, the scent output control unit 120 selects the scent (scent cartridge) selected by the user, acquires the scent output region, timing, interval, and scent output mode corresponding to the selected scent from the mode-correspondence scent database, and outputs the scent in the scent output mode according to the acquired information.

(Step S155)

On the other hand, in step S153, when the user selection information for the displayed scent cartridge list data has not been input within the prescribed time, the process proceeds to step S155.

In this case, in step S155, the scent output control unit 120 selects a default scent specified for rough summer closing, for example, a recommended scent cartridge, acquires a scent output region, timing, interval, and scent output mode corresponding to the selected scent from the mode-corresponding scent database, and outputs the scent in the scent output mode according to the acquired information.

In this manner, the scent output control device of the present disclosure can output an optimal scent according to various types of information input from the information acquisition unit 110 according to the mode recorded in the mode-corresponding scent database, specifically, the definition of the scent output timing, area, interval, and other detailed scent output mode.

Note that the scent output mode recorded in the mode-corresponding scent database includes each piece of information described above with reference to FIG. 10, that is, each piece of information of (1) type of scent, (2) blend blending, (3) concentration, amount, (4) direction time, (5) strength, (6) duty ratio, (7) spread, (8) distance, (9) temporal intensity change, (10) temporal aroma tone change, and (11) fade IN/OUT. The scent output control device of the present disclosure performs scent output control according to these pieces of information.

[6. Business Development Example Using Scent Output Control Processing of the Present Disclosure]

Next, a business development example using the scent output control process of the present disclosure will be described.

As described above, the scent output control device 100 of the present disclosure performs control to input information from each of the constituent elements of the information acquisition unit 110, that is, the environment information acquisition unit 111, the operation information acquisition unit 112, the biological information acquisition unit 113, the voice information acquisition unit 114, the internet, the broadcast (TV, radio, web, SNS, etc.) information acquisition unit 115, the position information acquisition unit (GLASS) 116, the advertisement information acquisition unit 117, and output various scents according to mode settings on the basis of these pieces of information.

The setting of the scent cartridge that outputs the scent can be variously set.

For example, a plurality of scents can be collectively switched and output to the scent cartridge, and one or a plurality of cartridges can be used to make it possible to use a scent cartridge set for sightseeing around specialty of Japan prefecture, a scent cartridge set for traveling in France, a cartridge set for soccer stadium hunting, and the like, and it is possible to perform processing of wearing and using the scent cartridge according to the purpose of the user's travel.

For example, the following process can be performed by using the scent output control device of the present disclosure.

By acquiring position information by a GNSS or a navigation system, a scent is output when a target position is approached.

When an occupant of the vehicle utters “udon” or inputs “udon” as a search word to the navigation system, a scent of udon is output.

Thus, by using the device of the present disclosure, it is possible to perform various types of scent output based on various types of information.

For example, as a sales strategy of the scent cartridge, the following processing can be performed.

In collaboration with fashion brands, perfumes suitable for stores around the world are determined, and cartridges including each perfume are sold. Furthermore, it is possible to develop services such as product introduction through a network, a navigation system, or the like.

In addition, in the scent output control device of the present disclosure, the scent output control is performed according to various mode settings, and these are executed as processing according to the registration information in the mode-corresponding scent database.

As described above, the registration information of the mode-corresponding scent database can be freely changed by the user, and a scent according to the user's preference can be output.

For example, in a case where the user approaches the “workplace”, it is set to output a scent for raising the “concentration level”, and in a case where the user approaches the “home”, it is possible to output a scent desired by the user according to the situation, such as outputting a scent for relaxing.

As described above, by using the scent output control device of the present disclosure, it is possible to realize new three-dimensional feeling, daily interactivity, and further entertainment through the scent.

By outputting a scent suitable for the environment and a scent related to peripheral information, a new value can be added to the movement of the vehicle. For example, in a case where there is a demand for attracting a large number of tourists or customers, such as a regional organization (tourist spot) or a store, it is possible to output the scent for each region or store by registering the position of the regional organization (tourist spot) or the store in advance in the position corresponding scent database.

[7. Hardware Configuration Example of Scent Output Control Device]

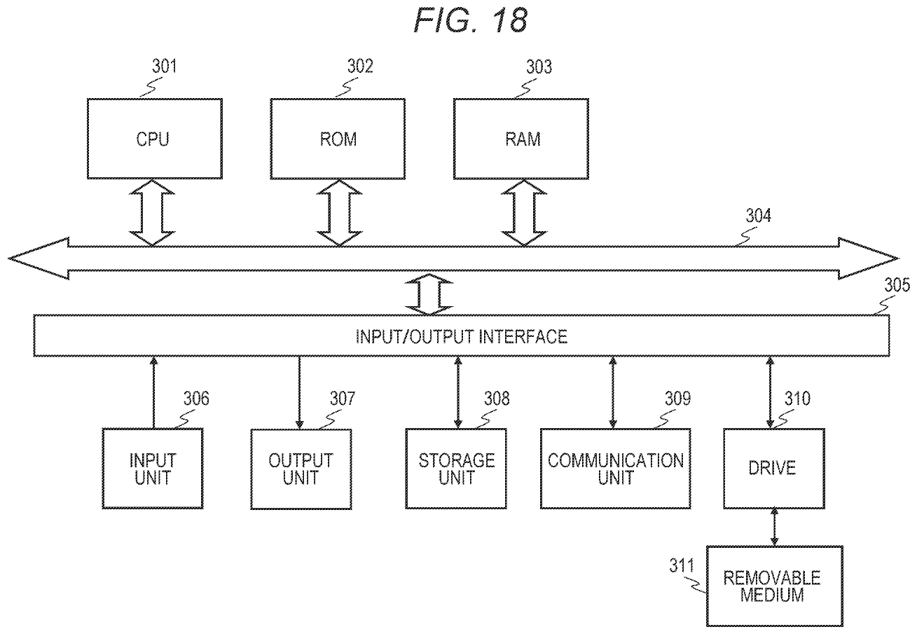

Next, a specific hardware configuration example of the scent output control device that executes the above-described processing will be described with reference to FIG. 18. This is a hardware configuration example applicable as a scent output control device mounted on a vehicle. Note that the scent output mode determination server can also be implemented as a device having the hardware configuration illustrated in FIG. 18.

FIG. 18 is a diagram illustrating an example of a hardware configuration of the scent output control device.

A central processing unit (CPU) 301 functions as a data processing unit that executes various processes according to a program stored in a read only memory (ROM) 302 or a storage unit 308. For example, processing according to the sequence described in the above-described embodiment is executed. A random access memory (RAM) 303 stores programs executed by the CPU 301, data, and the like. The CPU 301, the ROM 302, and the RAM 303 are mutually connected by a bus 304.

The CPU 301 is connected to an input/output interface 305 via the bus 304, and the input/output interface 305 is connected to an input unit 306 including various switches, a keyboard, a touch panel, a mouse, a microphone, a data acquisition unit such as a sensor, a camera, a GPS, or a GNSS, and the like, and an output unit 307 including a display, a speaker, and the like. Note that the scent output unit is also a component of the output unit 307.

The CPU 301 inputs commands, situation data, and the like input from the input unit 306, executes various types of processing, and outputs processing results to the output unit 307, for example.

The storage unit 308 connected to the input/output interface 305 includes, for example, a hard disk and the like, and stores programs executed by the CPU 301 and various data. The communication unit 309 functions as a transmission/reception unit for data communication via a network such as the Internet or a local area network, and communicates with an external device.

A drive 310 connected to the input/output interface 305 drives a removable medium 311 such as a magnetic disk, an optical disk, a magneto-optical disk, or a semiconductor memory such as a memory card, and records or reads data.

[8. Summary of Configuration of Present Disclosure]

Hereinabove, the embodiments of the present disclosure have been described in detail with reference to specific embodiments. However, it is obvious that those skilled in the art can make modifications and substitutions of the embodiments without departing from the gist of the present disclosure. That is, the present invention has been disclosed in the form of exemplification, and should not be interpreted in a limited manner. In order to determine the gist of the present disclosure, the claims should be taken into consideration.

Note that the technology disclosed in the present specification can have the following configurations.

(1) A scent output control device including:

a scent output control unit configured to execute scent output control; and

a scent output unit configured to execute a scent output under control of the scent output control unit, and

in which the scent output control unit

is configured to select a scent to be output according to input information from an information acquisition unit, and output the selected scent via the scent output unit, and

select information to be used for scent selection from the input information according to a preset mode, and select a scent to be output according to the selected input information.

(2) The scent output control device described in (1), in which the scent output unit is configured to output a scent into an automobile.

(3) The scent output control device described in (2), in which the information acquisition unit includes at least two of

(a) an environment information acquisition unit configured to acquire environment information;

(b) an operation information acquisition unit configured to acquire operation information of a vehicle;

(c) a biological information acquisition unit configured to acquire biological information of an occupant in a vehicle;

(d) a voice information acquisition unit configured to acquire voice information;

(e) a network and broadcast information acquisition unit configured to acquire at least one of network information or broadcast information;

(f) a position information acquisition unit configured to acquire position information; and

(g) an advertisement information acquisition unit configured to acquire advertisement information.

(4) The scent output control device described in (3), in which the scent output control unit selects one of the information acquired by the information acquisition unit of (a) to (g) according to a preset mode, and selects according to the selected input information.

(5) The scent output control device described in any one of (1) to (4), in which the scent output control unit

selects a mode-correspondence scent database according to a preset mode, and

executes the scent output control according to a scent output mode registered in the selected mode-correspondence scent database.

(6) The scent output control device described in (5), in which

an identifier of a scent output cartridge to be applied to a scent output is registered in the mode-correspondence scent database, and

the scent output control unit executes a scent output using the scent output cartridge registered in the mode-correspondence scent database.

(7) The scent output control device described in (5), in which

a plurality of identifiers of the scent output cartridge to be applied to the scent output is registered in the mode-correspondence scent database, and

the scent output control unit generates display information for causing a user to select a scent cartridge to be used from among the plurality of scent output cartridges registered in the mode-correspondence scent database and displays the generated display information on a display unit.

(8) The scent output control device described in any one of (1) to (7), in which the scent output control unit is one component of the information acquisition unit device, and selects a scent to be output according to a user utterance word acquired by a voice information acquisition unit that acquires voice information, and outputs the selected scent via the scent output unit.

(9) The scent output control device described in any one of (1) to (8), in which the scent output control unit

is one component of the information acquisition unit, and

selects a scent to be output according to an appearance word in a network for acquiring at least one of network information or broadcast information, the network acquired by the broadcast information acquisition unit, or the broadcast information, and outputs the selected scent via the scent output unit.

(10) The scent output control device described in any one of (1) to (9), in which the scent output control unit generates display information for causing a user to select the mode and displays the generated information on a display unit.

(11) The scent output control device described in any one of (1) to (10), in which a mode that can be set in the scent output control device includes at least two of

(A) a current location correspondence mode;

(B) a word correspondence mode;

(C) an environment correspondence mode;

(D) an operation state correspondence mode;

(E) a biological state correspondence mode;

(F) an advertisement correspondence mode; and

(G) an all acquired information correspondence mode.

(12) A scent output control system including: a scent output control device configured to execute a scent output process; and a scent output mode determination server configured to determine a scent to be output in the scent output control device,

in which the scent output control device transmits information acquired by an information acquisition unit to the scent output mode determination server,

the scent output mode determination server determines a scent to be output according to information received from the scent output control device, and transmits information on the determined scent to the scent output control device,

the scent output control device outputs the scent determined by the scent output mode determination server via a scent output unit, and

the scent output control device selects information to be used for scent selection from the information acquired by the information acquisition unit according to a preset mode, and transmits the selected information to the scent output mode determination server.

(13) The scent output control system described in (12), in which the information acquisition unit of the scent output control device includes at least two of

(a) an environment information acquisition unit configured to acquire environment information;

(b) an operation information acquisition unit configured to acquire operation information of a vehicle;

(c) a biological information acquisition unit configured to acquire biological information of an occupant in a vehicle;

(d) a voice information acquisition unit configured to acquire voice information;

(e) a network and broadcast information acquisition unit configured to acquire at least one of network information or broadcast information;

(f) a position information acquisition unit configured to acquire position information; and

(g) an advertisement information acquisition unit configured to acquire an advertisement information, and

the scent output control device selects one of the information acquired by the information acquisition units of (a) to (g) according to a preset mode, and transmits the selected information to the scent output mode determination server.

(14) A scent output control method executed in a scent output control device, in which

the scent output control device includes:

a scent output control unit configured to execute scent output control; and

a scent output unit configured to execute a scent output under control of the scent output control unit, and

the scent output control unit

executes a process of selecting a scent to be output according to input information from an information acquisition unit, and outputting the selected scent via the scent output unit, and

selects information to be used for scent selection from the input information according to a preset mode, and selects a scent to be output according to the selected input information.

(15) A scent output control method executed in a scent output control system including a scent output control device configured to execute a scent output process, and a scent output mode determination server configured to determine a scent to be output in the scent output control device, in which

the scent output control device selects information to be used for scent selection from information acquired by an information acquisition unit according to a preset mode, and transmits the selected information to the scent output mode determination server,

the scent output mode determination server determines a scent to be output according to information received from the scent output control device, and transmitting information on the determined scent to the scent output control device, and

the scent output control device outputs the scent determined by the scent output mode determination server via a scent output unit.

(16) A program for causing a scent output control device to execute scent output control processing, in which

the scent output control device includes:

a scent output control unit configured to execute scent output control; and

a scent output unit configured to execute a scent output under control of the scent output control unit, and

the program causes the scent output control unit to:

execute a process of selecting a scent to be output according to input information from an information acquisition unit, and outputting the selected scent via the scent output unit; and

select information to be used for scent selection from the input information according to a preset mode, and select a scent to be output according to the selected input information.

The series of processing described in the specification can be executed by hardware, software, or a combined configuration of both. In the case of executing processing by software, a program recording a processing sequence can be installed and executed in a memory in a computer incorporated in dedicated hardware, or the program can be installed and executed in a general-purpose computer capable of executing various types of processing. For example, the program can be recorded in advance in a recording medium. In addition to installation from the recording medium to the computer, the program can be received via a network such as a local area network (LAN) or the Internet and installed in a recording medium such as a built-in hard disk.

Note that the various types of processing described in the specification may be executed not only in time series according to the description but also in parallel or individually according to the processing capability of the device that executes the processing or as necessary. In addition, in the present specification, a system is a logical set configuration of a plurality of devices, and is not limited to a system in which devices of respective configurations are in the same housing.

### INDUSTRIAL APPLICABILITY

Hereinabove, as described above, according to the configuration of an embodiment of the present disclosure, the device and method for controlling a scent to be output on the basis of various types of information acquired by an information acquisition unit are realized.

Specifically, for example, a scent output control unit that executes scent output control and a scent output unit that executes a scent output under the control of the scent output control unit are included, and the scent output control unit selects a scent to be output according to the input information from the information acquisition unit and outputs the selected scent via the scent output unit. The scent output control unit selects information to be used for scent selection from the input information according to a preset mode, and selects a scent to be output according to the selected input information. For example, the control of the scent to be output is executed on the basis of a user utterance or information of an area, a facility, or the like.

With this configuration, the device and method for controlling a scent to be output on the basis of various types of information acquired by the information acquisition unit are realized.

### REFERENCE SIGNS LIST

100 Scent output control device
101 Environment sensor
102 Vehicle operation sensor
103 Biological sensor
104 Microphone
105 Communication unit
106 Storage unit
110 Information acquisition unit
111 Environment information acquisition unit
112 Operation information acquisition unit
113 Biological information acquisition unit
114 Voice information acquisition unit
115 Network, broadcast (TV, radio, web, SNS, or the like) information acquisition unit
116 Position information acquisition unit (GNSS)
117 Advertisement information acquisition unit
120 Scent output control unit
121 Scent output mode determination unit
122 UI control unit
123 Scent output unit control unit
130 Input/output unit (UI)
150 Scent output unit
151 Blower drive unit
152 Flow path control unit
153 Scent selection output unit
171 Map and facility data
172 Position and facility correspondence scent database
173 Word correspondence scent database
210 Scent output state determination server
301 CPU
302 ROM
303 RAM
304 Bus
305 Input/output interface
306 Input unit
307 Output unit
308 Storage unit
309 Communication unit
310 Drive
311 Removable medium

1. A scent output control device, comprising:
a scent output control unit configured to execute scent output control; and
a scent output unit configured to execute a scent output under control of the scent output control unit,
wherein the scent output control unit
is configured to select a scent to be output according to input information from an information acquisition unit, and output the selected scent via the scent output unit, and
select information to be used for scent selection from the input information according to a preset mode, and select a scent to be output according to the selected input information.

2. The scent output control device according to claim 1, wherein the scent output unit is configured to output a scent into an automobile.

3. The scent output control device according to claim 1, wherein
the information acquisition unit includes at least two of
(a) an environment information acquisition unit configured to acquire environment information;
(b) an operation information acquisition unit configured to acquire operation information of a vehicle;
(c) a biological information acquisition unit configured to acquire biological information of an occupant in a vehicle;
(d) a voice information acquisition unit configured to acquire voice information;
(e) a network and broadcast information acquisition unit configured to acquire at least one of network information or broadcast information;
(f) a position information acquisition unit configured to acquire position information; and
(g) an advertisement information acquisition unit configured to acquire advertisement information.

4. The scent output control device according to claim 3, wherein the scent output control unit selects one of the information acquired by the information acquisition unit of (a) to (g) according to a preset mode, and selects according to the selected input information.

5. The scent output control device according to claim 1, wherein the scent output control unit
selects a mode-correspondence scent database according to a preset mode, and
executes the scent output control according to a scent output mode registered in the selected mode-correspondence scent database.

6. The scent output control device according to claim 5, wherein
an identifier of a scent output cartridge to be applied to a scent output is registered in the mode-correspondence scent database, and
the scent output control unit executes a scent output using the scent output cartridge registered in the mode-correspondence scent database.

7. The scent output control device according to claim 5, wherein
a plurality of identifiers of the scent output cartridge to be applied to the scent output is registered in the mode-correspondence scent database, and
the scent output control unit generates display information for causing a user to select a scent cartridge to be used from among the plurality of scent output cartridges registered in the mode-correspondence scent database and displays the generated display information on a display unit.

8. The scent output control device according to claim 1, wherein the scent output control unit is one component of the information acquisition unit device, and selects a scent to be output according to a user utterance word acquired by a voice information acquisition unit that acquires voice information, and outputs the selected scent via the scent output unit.

9. The scent output control device according to claim 1, wherein
the scent output control unit
is one component of the information acquisition unit, and
selects a scent to be output according to an appearance word in a net for acquiring at least one of net information or broadcast information, the net acquired by the broadcast information acquisition unit, or the broadcast information, and outputs the selected scent via the scent output unit.

10. The scent output control device according to claim 1, wherein the scent output control unit generates display information for causing a user to select the mode and displays the generated information on a display unit.

11. The scent output control device according to claim 1, wherein
a mode that is set in the scent output control device includes at least two of
(A) a current location correspondence mode;
(B) a word correspondence mode;
(C) an environment correspondence mode;
(D) an operation state correspondence mode;
(E) a biological state correspondence mode;
(F) an advertisement correspondence mode; and
(G) an all acquired information correspondence mode.

12. A scent output control system, comprising: a scent output control device configured to execute a scent output process; and a scent output mode determination server configured to determine a scent to be output in the scent output control device,
wherein the scent output control device transmits information acquired by an information acquisition unit to the scent output mode determination server,
the scent output mode determination server determines a scent to be output according to information received from the scent output control device, and transmits information on the determined scent to the scent output control device,
the scent output control device outputs the scent determined by the scent output mode determination server via a scent output unit, and
the scent output control device selects information to be used for scent selection from the information acquired by the information acquisition unit according to a preset mode, and transmits the selected information to the scent output mode determination server.

13. The scent output control system according to claim 12, wherein
the information acquisition unit of the scent output control device includes at least two of
(a) an environment information acquisition unit configured to acquire environment information;
(b) an operation information acquisition unit configured to acquire operation information of a vehicle;
(c) a biological information acquisition unit configured to acquire biological information of an occupant in a vehicle;
(d) a voice information acquisition unit configured to acquire voice information;
(e) a network and broadcast information acquisition unit configured to acquire at least one of network information or broadcast information;
(f) a position information acquisition unit configured to acquire position information; and
(g) an advertisement information acquisition unit configured to acquire an advertisement information, and
the scent output control device selects one of the information acquired by the information acquisition units of (a) to (g) according to a preset mode, and transmits the selected information to the scent output mode determination server.

14. A scent output control method executed in a scent output control device,
wherein the scent output control device includes:
a scent output control unit configured to execute scent output control; and
a scent output unit configured to execute a scent output under control of the scent output control unit, and
the scent output control unit
executes a process of selecting a scent to be output according to input information from an information acquisition unit, and outputting the selected scent via the scent output unit, and
selects information to be used for scent selection from the input information according to a preset mode, and selects a scent to be output according to the selected input information.

15. A scent output control method executed in a scent output control system including a scent output control device configured to execute a scent output process, and a scent output mode determination server configured to determine a scent to be output in the scent output control device,
wherein the scent output control device selects information to be used for scent selection from information acquired by an information acquisition unit according to a preset mode, and transmits the selected information to the scent output mode determination server,
the scent output mode determination server determines a scent to be output according to information received from the scent output control device, and transmits information on the determined scent to the scent output control device, and
the scent output control device outputs the scent determined by the scent output mode determination server via a scent output unit.

16. A program for causing a scent output control device to execute scent output control processing,
wherein the scent output control device includes:
a scent output control unit configured to execute scent output control; and
a scent output unit configured to execute a scent output under control of the scent output control unit, and
the program causes the scent output control unit to:
execute a process of selecting a scent to be output according to input information from an information acquisition unit, and outputting the selected scent via the scent output unit; and
select information to be used for scent selection from the input information according to a preset mode, and select a scent to be output according to the selected input information.
